(19) United States
(12) Patent Application Publication
(10) Pub. No.: US 2009/0156404 A1
(43) Pub. Date: Jun. 18, 2009

(54) Methods and Compositions for Reducing Stress in Plants

(75) Inventor: Charles Christian Kupatt, JR., Apex, NC (US)

Correspondence Address: COATS & BENNETT, PLLC, 1400 Crescent Green, Suite 300, Cary, NC, 27518, US

(73) Assignee: CROP MICROCLIMATE MANAGEMENT, INC., Apex, NC (US)

(21) Appl. No.: 11/959,285

(22) Filed: Dec. 18, 2007

(51) Int. Cl. A01N 37/10; A01N 25/00; A01N 25/02; A01N 37/00

(52) U.S. Cl. 504/324; 504/358; 504/362; 504/320

(57) ABSTRACT

The present application is directed to methods and compositions for improving growth or yield of plants by reducing stress from abiotic factors without adversely affecting photosynthesis. In one embodiment, the compositions include particulate material and one or more plant growth regulating compounds such as non-gaseous plant hormones, amino acids and amino acid derivatives, and terpenes, and mixtures thereof. The composition is applied to at least part of the surface of the plant, forming a film on the plant. The effects of abiotic factors such as heat, cold, light, and water stress may be reduced or eliminated after application of the composition, and growth or yield may be increased while photosynthesis is not adversely affected.

### BACKGROUND

The present application relates generally to growth or yield of plants, and more specifically to methods and compositions for improving growth or yield of plants by reducing stress from abiotic factors.

Photosynthesis is the process by which plants convert light energy into chemical energy and is associated with the actions of the green pigment chlorophyll. The raw materials used by the plants are carbon dioxide and water, which are converted during the photosynthetic process to glucose and oxygen according to the following simplified chemical reaction:

6CO₂+6H₂O→C₆H₁₂O₆+6O₂

Cellular respiration may then convert the glucose into adenosine triphosphate (ATP), a compound used by plant cells for energy storage. ATP is made of the nucleotide adenine bonded to a ribose sugar, which in turn is bonded to three phosphate groups. ATP may be used by the plant immediately as a food nutrient, or may undergo further chemical reactions through cellular respiration to form monosaccharide sugars such as glucose. Further, the glucose can be transported to other cells within the plant, or converted to polysaccharides such as starch for later use.

There are two aspects to photosynthesis, called the light and dark reactions. The light reaction converts light energy to chemical energy. This chemical reaction must, therefore, take place in the light. Chlorophyll and several other pigments such as carotenes and xanthophylls are organized in clusters within the leaves of plants and are involved in the light reaction. Each of these pigments can absorb a slightly different color of light and pass its energy to the central chlorophyll molecule for the photosynthesis reaction. The energy captured by the light reaction is stored by forming ATP.

The dark reaction takes place in the stoma within the chloroplast, and converts CO₂ to sugar. This reaction is known as carbon fixation because the carbon from the CO₂ molecule is converted into organic compounds that can be used by the plant. The dark reaction involves a cycle called the Calvin cycle in which CO₂ and energy from ATP are used to form sugar.

Photosynthesis may be impacted by plant stress induced by abiotic factors. For example, the energy capturing mechanism of the light reaction is membrane bound and can be impaired or disrupted by excess heat and solar radiation. High levels of light may also induce photoinhibition, which is a reduction in a plant's capacity for photosynthesis. Photoinhibition is caused by absorption of too much light energy compared with the photosynthetic capacity. This excess energy can result in the formation of reactive oxygen species which may be damaging to the photosynthetic structures. Reactive oxygen species may also trigger or signal stress responses within the plant and lead to reduction in growth.

### SUMMARY

The present application is directed to methods and compositions for improving growth or yield of plants by reducing stress from abiotic factors without adversely affecting photosynthesis. In one embodiment, the composition includes particulate material and one or more plant growth regulating compounds such as non-gaseous plant hormones, amino acids and amino acid derivatives, and terpenes and mixtures thereof. The composition is applied to at least part of the surface of the plants, forming a film on the plants. The effects of abiotic factors such as heat, cold, light, and water stress may be reduced or eliminated after application of the composition, and growth or yield may be increased while photosynthesis is not adversely affected.

### DETAILED DESCRIPTION

The present application is directed to methods and compositions for improving growth or yield of plants by reducing stress from abiotic factors without adversely affecting photosynthesis. In one embodiment, the composition includes particulate material and one or more plant growth regulating compounds such as non-gaseous plant hormones, amino acids and amino acid derivatives, and terpenes. In one embodiment, the particulate material and the plant growth regulating compound are mixed with a volatile liquid such as water. The suspension is then applied to at least part of the surface of the plant, forming a film on the plant. The film may be continuous or non-continuous. The effects of abiotic factors such as heat, cold, light, and water stress may be reduced or eliminated after application of the composition, and growth or yield may be increased while photosynthesis is not adversely affected.

The plants to which this application may be beneficial include agricultural and forest crops and ornamental plants such as fruits, vegetables, grains, trees, flowers, grasses, roots, seeds, shrubbery, herbs, mosses, lichens, and algae. In general, any plant that uses photosynthesis may experience beneficial stress reducing effects from the methods and compositions disclosed. Any portion of the plant which is exposed to sunlight may be treated with the composition, including stems, nodes, stalks, branches, petioles, leaves, shoots, buds, flowers, and fruit. The composition may be applied to plants of any age.

Particulate materials that may be used in the composition include particles that reflect a substantial portion of incident light (sunlight); that is, the materials have a high brightness. Additionally, the particulate material may refract the incident light. In one embodiment, the particulate material has a Block Brightness of at least about 80 as obtained by measuring a sample of the particulate material using TAPPI Test Method T 646. In another embodiment, the particulate material has a Block Brightness greater than about 90. Minerals such as calcium carbonate, talc, kaolin (calcined or hydrous), bentonite, clay, pyrophyllite, silica, feldspar, sand, quartz, chalk, limestone, calcium carbonate, brucite, diatomaceous earth, barite, and aluminum trihydrate may be used. In general, the particulate materials are not phytotoxic (i.e., are inert), and may not be considered harmful to the plants or to humans and animals that consume the plants when used in concentrations specified in the present application.

In one embodiment, the particulate material is finely divided. The size of the particles making up the particulate material can vary. In one example, a substantial portion of the particulate material includes particles having a size less than about 10 microns. The particle size may be measured with a Micrometrics Sedigraph 5100 particle size analyzer. In another example, the particle size is less than about 1 micron. About 75 percent of the particles have a size less than about 10 microns in one embodiment, while in another embodiment about 75 percent of the particles have a size less than about 1 micron.

An example of a suitable particulate material that is commercially available is Microbrite®, a kaolin available from Skardon River Kaolin Pty. Ltd., Cairns, Queensland, Australia. Other examples include Atomite® and Supermite®, which are calcium carbonates available from English China Clays Plc, Reading, United Kingdom, and Supercoat® and Kotamite®, which are stearic acid treated ground calcium carbonates also available from English China Clay.

Plant growth regulating compounds that may be useful in the composition include non-gaseous plant hormones, amino acids and amino acid derivatives, and terpenes, and mixtures thereof. While the exact mechanisms are not completely understood, it is hypothesized that these compounds play a role in counteracting stress coping mechanisms within plants by adjusting photosynthetic rates and/or adjusting the response of various plant cells.

Non-gaseous plant hormones are chemicals that regulate plant growth. In general, non-gaseous plant hormones are produced in diffuse areas of the plant in very low concentration and may affect growth, development, and differentiation of cells. Non-gaseous plant hormones are generally divided into four major groups: abscisic acid, auxins, cytokinins, and gibberellins.

Abscisic acid is a naturally occurring compound in plants and is synthesized primarily in the leaves originating from chloroplasts. The production of abscisic acid is more pronounced under stress caused by water loss, and affects bud growth, as well as bud and seed dormancy by inhibiting growth. During periods of water stress, abscisic acid helps to close the stomata thereby reducing water vapor loss.

Auxins typically induce cell elongation in the stem of the plant by altering cell wall plasticity, and influence bud formation and root initiation. Auxins decrease in light and increase in dark conditions, thereby helping plants to cope with stress induced by a lack of sunlight. Auxins also work advantageously with other plant hormones. For example, in combination with cytokinins, auxins control the growth of stems, roots, flowers, and fruits. Auxins include 4-chlorophenoxyacetic acid, (2,4-dichlorophenoxy)acetic acid, 4-(2,4-dichlorophenoxy)butyric acid, tris[2-(2,4-dichlorophenoxy)ethyl] phosphate, 2-(2,4-Dichlorophenoxy)propanoic acid, 2-(2,4,5-trichlorophenoxy)propanoic acid, indole-3-acetic acid, indole-3-butyric acid, 1-naphthaleneacetamide, 1-naphthaleneacetic acid, 1-naphthol, naphthoxy acetic acid, naphthenic acid, and (2,4,5-trichlorophenoxy)acetic acid.

Cytokinins influence cell division and shoot formation. Because cytokinins help delay the aging of plant tissues and affect internodal length and leaf growth, these compounds may reduce the effect of stresses that slow down plant growth. Examples of cytokinins include 6-(4-hydroxy-3-methylbut-2-enylamino)purine, dihydrozeatin, N⁶-(Δ²-isopentenyl)-adenine, N⁶-(Δ²-isopentenyl)-adenosine, ribosylzeatin, ribosylzeatin-5′-monophosphate, and 2-methylthio-cis-ribosylzeatin.

Gibberellins influence seed germination and promote enzyme production that in turn stimulates food production that is needed for new cell growth. These compounds also increase internodal length and promote flowering and cellular division. Because gibberellins act to reverse the inhibition of shoot growth and dormancy induced by abscisic acid, they may aid recovery from stress induced by lack of water. A variety of Gibberellins have been identified, and are named GA₁ . . . GAₙ in order of discovery. Gibberillic acid is GA₃.

A variety of other non-gaseous plant hormones may also be advantageously used in the compositions of the present application. Non-limiting examples include brassinolides, jasmonates, signaling peptides, salicylic acid and other phenolic acids and their salts, and systemin. Additionally, non-gaseous plant hormones may form complexes with other compounds such as sugars and proteins. As used herein, the term “non-gaseous plant hormone” encompasses complexed non-gaseous plant hormones.

Plants may regulate plant hormones by conjugating them with amino acids and amino acid derivatives (amino acids which have undergone structural transformation or chemical modification of one or more functional groups). Amino acids and derivatives may also negate the activity of plant hormones, rendering them inactive. Therefore, application of amino acids and derivatives may be useful in treating stress in the plants. For example, selected amino acids and derivatives may have the same general effect as described above for gibberellins in reversing the effects of abscisic acid. Additionally, the amino acid derivative 1-aminocyclopropane-1-carboxylic acid is a key intermediate in the production of ethylene within the plant. Ethylene is known to cause thicker and stronger stems in response to lateral stress caused by wind.

The “standard” amino acids are alanine, cysteine, aspartic acid, glutamic acid, phenylalanine, glycine, histidine, isoleucine, lysine, leucine, methionine, asparagines, praline, glutamine, arginine, serine, threonine, selenocysteine, valine, tryptophan, and tyrosine. In addition, there are numerous “non-standard” amino acids, or amino acid derivatives. Examples include trimethylglycine, DL-2-aminobutyric acid, DL-3-amino-n-butanoic acid selenocysteine, pyrrolysine, lanthionine, 2-aminoisobutyric acid, dehydroalanine and gamma-aminobutyric acid.

The final group of plant growth regulating compounds is terpenes. Terpenes are a class of hydrocarbons produced primarily in a variety of plants, and consist of multiple isoprene units. Terpenes that have undergone rearrangement of the carbon skeleton or other chemical rearrangement such as oxidation are known as terpenoids. While terpenoids as a group include non-cyclic compounds, many terpenoids include an aromatic hydrocarbon (i.e., a benzene ring) structure, or a polyaromatic structure. Many of these cyclic terpenoids are found naturally in plants and have been found to affect photosynthetic rates and play a role in drought-induced stress response. As used herein, the term “terpenes” encompasses terpenoids and cyclic terpenoids. Examples of cyclic terpenoids that may be advantageously used in the composition of the present application include benzyl acetate, idebenone, furocoumarine, pinene, 2-carene, phellandrene, limonene, and geraniol. A number of plant growth regulating compounds may be classified as both a terpene and a plant hormone.

In one embodiment, the composition may include one plant growth regulating compound. In another embodiment, more than one plant growth regulating compound may be included in the composition. By selectively choosing the plant growth regulating compound, compositions may be formulated to target specific stresses and/or specific plants.

The plant growth regulating compounds may be derived naturally from a variety of plants, or may be produced synthetically. Both natural and synthetic plant growth regulating compounds may be used in the compositions described herein.

The amount of particulate matter in the composition may vary, and may be selected to provide a coating on the surface of the plant sufficient to reflect enough sunlight to reduce stress in the particular plant treated, while still allowing enough light to reach the surface of the plant such that the rate of photosynthesis is not adversely affected. While the exact amount applied is dependent on a variety of factors, one embodiment includes an application rate of about 25 to about 5000 micrograms of particulate material per square centimeter of plant surface area. Another embodiment includes an application rate of about 5 to about 100 kilograms per hectare. The application rate of the particulate material may be dependent upon the brightness of the particulate matter. As the brightness increases, a lesser amount may need to be applied to achieve the desired amount of light reflectance.

The concentration of the plant growth regulating compound may also vary in the composition. Factors that influence the concentration include, but are not limited to, the specific plant growth regulating compound chosen for the composition, whether more than one plant growth regulating compound is included in the composition, the specific plant being treated, and the desired effect on the plant. In one embodiment, the concentration of the plant growth regulating compound may vary between about 1×10⁻⁹ molar and about 1×10⁻³ molar. Alternately, the concentration of the plant growth regulating compound may be expressed in terms of the application rate. In one embodiment, the application rate of the plant growth regulating compound is about 0.01 to about 1000 grams per hectare.

In addition to varying the individual concentration of the particulate material and the plant growth regulating compound in the compoistion, the relative proportion of each can vary in the composition as well. The amount of the particulate material and the plant growth regulating compound in the composition can be expressed in terms of a mass ratio. The ratio may be determined by dividing the mass of the particulate material in the composition by the mass of the plant growth regulating compound in the composition. In one embodiment, the ratio ranges from about 5:1 to about 1:1×10⁻⁷. The ratio may also be expressed at the reciprocal value.

The composition is typically produced by first selecting one or more particulate materials and one or more plant growth regulating compounds. The particulate material and the plant growth regulating compound may then be mixed, forming an essentially dry material. This dry material may be supplied directly to the user for direct application to the plants, or for the user to mix with an aqueous medium, such as water, prior to application. Alternately, the particulate material and plant growth regulating compound may be mixed with the aqueous medium before being supplied to the user. The resulting aqueous mixture may be supplied in a concentrate form which is further diluted, or in a ready to use form. The aqueous medium may also include one or more low boiling point organic solvents.

In addition to the particulate material and the plant growth regulating compound, the composition may include a variety of ingredients to aid in the preparation and use of the composition. These ingredients may include surfactants, dispersants, spreaders, wetting agents, stickers, drift reducing agents, and antifoaming agents. These ingredients are well known in the art and are not discussed further.

The amount of particulate material and water used will depend on application factors specific to each situation. As stated above, one embodiment includes a particulate material application rate of about 5 to about 100 kilograms per hectare. As an example, an application rate of 50 kilograms per hectare is chosen for a particular situation. The number of hectares in the growing field would first be determined, which for this example is 75 hectares. Multiplying the number of hectares by the application rate yields the amount of particulate material needed: 50 kg/ha×75 ha=3750 kg. The amount of water (volatile liquid) is dependent on a variety of site-specific parameters. For example, the composition will be applied by some type of sprayer, which has a certain flow rate. The sprayer must be moved through the growing field, and thus moves at a certain speed. These factors must be taken into account to determine the amount of water (volatile liquid) used so that when the sprayer is moved over the entire field, the desired amount of particulate material is delivered. The same considerations may apply to the plant growth regulating compound as well.

In one embodiment, the composition may be applied in a single application. In another embodiment, a first application may be followed by one or more additional applications. The additional applications may be of the same composition (i.e., the same plant growth regulating compound) or may be of a different composition. For example, the first application may be a composition formulated to combat heat stress, while a second application may be a composition formulated to combat stress induced by lack of water. Alternatively, the first and second applications may be of different formulations selected to work advantageously together to achieve a common result.

### EXPERIMENTAL

### EXAMPLE 1

Greenhouse grown tomatoes (var. Marglobe) were treated prior to the 2007 Easter freeze event in North Carolina. Unadapted plants in trays were sprayed with a composition comprised of a particulate material and a plant growth regulating compound mixed with water. The composition was applied using a backpack sprayer in a factorial trial design. The particulate material used was kaolin, applied at 25 and 50 kg/ha. The particulate material had a Block Brightness of about 88, and about 99 percent of the particles were less than or equal to 10 microns. Two plant growth regulating compounds, methyl salicylate and sodium salicylate, were each mixed individually with the kaolin. In addition to combinations of kaolin and each of the plant growth regulating compounds, the experiment included applying kaolin alone and each of the plant growth regulating compounds alone, each mixed with water. The concentrations of each of the plant growth regulating compounds in the composition were 1×10⁻⁴M and 1×10⁻⁵M. The results showed that the particulate material can reduce tomato injury/death from exposures to −3.3° C. This protection was enhanced with the addition of the plant growth regulating compounds, although not with both compounds at all rates. Results from the analysis of variance showed a significant interaction between the particulate material application rate and the plant growth regulating compound application rate (p=0.009), as well as the particulate material rate across plant growth regulating compound rates.

| | Application Rate or | |
|---|---|---|
| Run | Concentration | Mortality (%) |
| Control | | 67.5 |
| Kaolin | 25 kg/ha | 22.5 |
| Kaolin + Na | 25 kg/ha + 1 × 10⁻⁴M | 0 |
| Salicylate | | |
| Kaolin + Na | 25 kg/ha + 1 × 10⁻⁵M | 0 |
| Salicylate | | |
| Na Salicylate | 1 × 10⁻⁴M | 83 |
| Na Salicylate | 1 × 10⁻⁵M | 6.3 |
| Control | | 67.5 |
| Kaolin | 25 kg/ha | 22.5 |
| Kaolin + Me | 25 kg/ha + 1 × 10⁻⁴M | 75 |
| Salicylate | | |
| Kaolin + Me | 25 kg/ha + 1 × 10⁻⁵M | 0 |
| Salicylate | | |
| Me Salicylate | 1 × 10⁻⁴M | 0 |
| Me Salicylate | 1 × 10⁻⁵M | 20 |

### EXAMPLE 2

In this example, a growth chamber was used to induce stress in plants. Tomatoes (var. Marglobe) were greenhouse grown, then adapted in the growth chamber for two days at a constant 20° C. and the highest light intensity produced by the growth chamber. The temperature was then programmed for a multi-step diurnal variation between about 4 and about 42° C. The plants were treated with a composition comprised of a particulate material and a plant growth regulating compound mixed with water. The particulate material used was Kaolin, applied at 25 and 50 kg/ha. The particulate material had a Block Brightness of about 88, and about 99 percent of the particles were less than or equal to 10 microns. The plant growth regulating compound was sodium salicylate, which was applied at 1×10⁻⁴M and 1×10⁻⁵M in the composition. In addition to combinations of kaolin and the plant growth regulating compound, the experiment included applying kaolin alone and the plant growth regulating compound alone, each mixed with water. After five days, untreated plants exhibited significant chlorosis. Treatment with kaolin alone provided some reduction in chlorosis (p=0.055). Treatment with both kaolin and sodium salicylate provided greater protection (p=0.001).

| | Application Rate or | | |
|---|---|---|---|
| Run | Concentration | Chlorosis (%) | Growth (cm) |
| Control | | 15 | 3.2 |
| Kaolin | 50 kg/ha | 13.8 | 1.2 |
| Kaolin | 25 kg/ha | 8.8 | 2.2 |
| Kaolin + Na | 50 kg/ha + 1 × 10⁻⁵M | 2.5 | 1.9 |
| Salicylate | | | |
| Kaolin + Na | 25 kg/ha + 1 × 10⁻⁵M | 1.3 | 1.4 |
| Salicylate | | | |
| Na Salicylate | 1 × 10⁻⁵M | 8.8 | 1.9 |
| Na Salicylate | 1 × 10⁻⁴M | 7.5 | 1.9 |

### EXAMPLE 3

Field-grown tomatoes (var. Better Boy) were treated three days after transplant into the field. Treatment consisted of a composition comprised of a particulate material and a plant growth regulating compound mixed with water. The particulate material was kaolin, applied at 25 and 50 kg/ha. The particulate material had a Block Brightness of about 88, and about 99 percent of the particles were less than or equal to 10 microns. The plant growth regulating compound was sodium salicylate, which was applied at a concentration of 1×10⁻⁵M in the composition. In addition to combinations of kaolin and the plant growth regulating compound, the experiment included applying kaolin alone and the plant growth regulating compound alone, each mixed with water. The trial was conducted in a grower field of sandy soil in Wake County, N.C. under grower conditions. The conditions were considered to be severe, as there was no irrigation and rainfall was insufficient during the trial. Treatments were applied at weekly intervals. The trial was a randomized complete block design with three replications. The results showed stress protection for the treated plants, with statistically significant differences between treatments. The greatest protection was provided by combinations of kaolin and sodium salicylate. The beneficial effects of the treatments included increased plant growth, increased flowering (less abortion due to high temperatures), and increased fruit clusters per plant. Treatment with kaolin or sodium salicylate alone provided values intermediate between the untreated plants and the plants treated with both.

| | Application | Rating 1 | Rating 2 | | Rating 3 | | |
|---|---|---|---|---|---|---|---|
| | Rate or | # flower | # flower | | # Mature | # clusters/ | |
| Run | Concentration | clusters/plant | clusters/plant | # Fruit > 2 cm | blossoms | plant | Fruit > 1 cm |
| Control | | 2.32 | 3.33 | 1.04 | 2.57 | 0.84 | 1.95 |
| Kaolin | 25 kg/ha | 2.09 | 3.27 | 1 | 2.64 | 0.74 | 1.71 |
| Kaolin | 50 kg/ha | 2.71 | 3.53 | 1 | 2.66 | 0.98 | 1.84 |
| Kaolin + Na | 25 kg/ha + 1 × 10⁻⁵M | 2.65 | 3.79 | 1.13 | 3 | 0.85 | 1.62 |
| Salicylate | | | | | | | |
| Kaolin + Na | 50 kg/ha + 1 × 10⁻⁵M | 3.49 | 3.97 | 1.4 | 3.49 | 1.26 | 2.17 |
| Salicylate | | | | | | | |
| Na | 1 × 10⁻⁵M | 2.61 | 3.78 | 1.05 | 2.89 | 0.75 | 1.46 |
| Salicylate | | | | | | | |

### EXAMPLE 4

In Wake County, N.C., early season tomatoes (var. Mountain Spring) were transplanted on Jul. 1, 2007, into sandy soil in a grower field. The trial was a randomized complete block design with four replications. The plants were sprayed with a composition comprised of a particulate material and a plant growth regulating compound mixed with water. The particulate material used was kaolin, applied at 25 and 50 kg/ha in an aqueous medium. The particulate material had a Block Brightness of about 88, and about 99 percent of the particles were less than or equal to 10 microns. The plant growth regulating compound was sodium salicylate applied at a concentration of 1×10⁻⁵M in the composition. In addition to combinations of kaolin and the plant growth regulating compound, the experiment included applying kaolin alone and the plant growth regulating compound alone, each mixed with water. The plots were ideally fertilized and watered by trickle irrigation, and the tomato plants were trellised. Flowering had begun at the time of the first application. There was no observable difference in vegetative growth between treatments. The plants treated with kaolin experienced reduced flower abortion rate of about 11 percent as compared to 28 percent for untreated plants. No significant differences were observed between the different rates of application or with the addition of sodium salicylate. Following the fourth application, new growth was left untreated to determine whether the sodium salicylate could extend the treatment benefits. Ratings following a period of extreme weather (daily high temperatures of 32-38° C.) showed that there was a benefit for the combination of kaolin and sodium salicylate in reducing flower abortion and fruit drop. The benefit was also seen with new growth. Kaolin alone provided protection for the covered areas, but flower and fruit drop was severe for untreated areas. It also appeared that the addition of sodium salicylate may reduce the required amount of kaolin applied.

Leaf water potential measurements were made on two days during the heat of the day. No differences in leaf water potential were observed between any of the treatments. While unexpected, this may have been a result of the high levels of available water provided by the irrigation system directly to the root zone.

| | | Rating 1 | Rating 2 |
|---|---|---|---|
| | Application Rate or | # Aborted | # Aborted |
| Run | Concentration | Flowers/Plant | Flowers/Plant |
| Control | | 28.41 | 5.44 |
| Kaolin | 25 kg/ha | 12.61 | 2.59 |
| Kaolin | 50 kg/ha | 20.74 | 2.49 |
| Kaolin + Na | 25 kg/ha + 1 × 10⁻⁵M | 12 | 3.92 |
| Salicylate | | | |
| Kaolin + Na | 50 kg/ha + 1 × 10⁻⁵M | 14.3 | 1.64 |
| Salicylate | | | |
| Na Salicylate | 1 × 10⁻⁵M | 20.75 | 3.94 |

### EXAMPLE 5

Potted tomatoes under field conditions were subjected to cold temperatures in Australia in September-October 2007. Although not subjected to freezing temperatures, the plants were highly chill stressed. The plants were sprayed with a composition comprised of particulate material and a plant growth regulating compound mixed with water. The particulate material used was kaolin, applied at 25 and 50 kg/ha. The particulate material had a Block Brightness of about 88, and about 99 percent of the particles were less than or equal to 10 microns. Two plant growth regulating compounds, sodium salicylate and benzyl acetate, were each mixed individually with the kaolin. The concentration of each plant growth regulating compound in the composition was 1×10⁻⁵M. In addition to combinations of kaolin and each of the plant growth regulating compounds, the experiment included applying kaolin alone and sodium salicylate alone each mixed with water. The vigor and health of the plants were evaluated during the period of the trial. The most beneficial effects were observed with compositions including both kaolin and benzyl acetate.

| | Application Rate | Application Rate for | 12/9/2007 | 26/09/2007 | 7/10/2007 |
|---|---|---|---|---|---|
| | for Particulate | Growth Compound | Plant | Plant | Plant |
| Run | (kg/ha) | (g/ha) | Vigor/Health | Vigor/Health | Vigor/Health |
| Control | | | 10 a | 3.7 c | 2.3 f |
| Kaolin | 25 | 0 | 10 a | 6.2 b | 3.5 e |
| Kaolin | 50 | 0 | 10 a | 6.2 b | 3.7 de |
| Kaolin + Na Salicylate | 25 | 0.8 | 10 a | 5.7 b | 4.2 cd |
| Kaolin + Na Salicylate | 25 | 1.6 | 10 a | 6.8 ab | 4.3 bc |
| Kaolin + Na Salicylate | 50 | 0.8 | 10 a | 6.7 ab | 4.7 bc |
| Kaolin + Na Salicylate | 50 | 1.6 | 10 a | 5.8 b | 4.8 b |
| Na Salicylate | 0 | 0.8 | 10 a | 6.5 ab | 7.7 a |
| Na Salicylate | 0 | 1.6 | 10 a | 6.5 ab | 7.3 a |
| Kaolin + Benzyl | 50 | 0.8 | 10 a | 7.8 a | 7.7 a |
| Acetate | | | | | |

| | | | |
|---|---|---|---|
| LSD (P = 0.05) | 0 | 1.54 | 0.64 |
| Standard Deviation | 0 | 1.32 | 0.55 |
| CV | 0 | 21.3 | 10.88 |

A Plant Vigor/Health rating of 10 is a completely healthy plant; a rating of 0 is dead. Ratings followed by the same letter are not statistically different.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A yield or growth regulating composition for plants that reduces stress from abiotic factors, the composition comprising:
a particulate material;
a plant growth regulating compound mixed with the particulate material;
the plant growth regulating compound selected from the group including non-gaseous plant hormones, amino acids or amino acid derivatives, and terpenes, and mixtures thereof; and
wherein by applying the yield or growth regulating composition to plants, the growth or yield of the plant is enhanced.

2. The composition of claim 1, wherein the particulate material comprises at least one of calcium carbonate, talc, calcined or hydrous kaolin, bentonite, clay, pyrophyllite, silica, feldspar, sand, quartz, chalk, limestone, brucite, diatomaceous earth, barytes, aluminum trihydrate, and titanium dioxide, and mixtures thereof.

3. The composition of claim 1, wherein a substantial portion of the particulate material includes particles of a size less than about 10 microns.

4. The composition of claim 1, wherein the particulate material includes particles, and wherein about 90 percent or more by weight of the particles have a particle size of about less than 10 microns.

5. The composition of claim 1, wherein the ratio of the mass of the particulate material to the mass of the plant growth regulating compound is in the range from about 5:1 to about 1:1×10⁻⁷.

6. The composition of claim 1, including an aqueous medium having the particulate material and the plant growth regulating compound mixed therein.

7. The composition of claim 1, wherein the plant growth regulating compound comprises at least one non-gaseous plant hormone.

8. The composition of claim 1, wherein the plant growth regulating compound comprises at least one amino acid or amino acid derivative.

9. The composition of claim 1, wherein the plant growth regulating compound comprises at least one terpene.

10. The composition of claim 1, wherein the plant growth regulating compound comprises at least one cyclic terpenoid.

11. The composition of claim 1, wherein the particulate material includes particles, and wherein the particles have a Block Brightness of about 80 or more.

12. The composition of claim 1, wherein the particulate material and the plant growth regulating compound are mixed with an aqueous medium, and wherein the concentration of the plant growth regulating compound in the composition ranges from about 1×10⁻³M to about 1×10⁻⁹M.

13. The composition of claim 1, wherein the particulate material includes particles and wherein 75 percent or more of the particles have a size less than about 10 microns; the particles having a Block Brightness of about 80 or more; and wherein the ratio of the mass of the particulate material to the mass of the plant growth regulating compound in the composition is in the range from about 5:1 to about 1:1×10⁻⁷.

14. The composition of claim 13, wherein the particulate material comprises calcined or hydrous kaolin.

15. The composition of claim 14, wherein the plant growth regulating compound comprises terpenes.

16. The composition of claim 7, wherein the non-gaseous plant hormone comprises at least one of abscisic acid, an auxin, a cytokinin, and a gibberellin, and mixtures thereof.

17. The composition of claim 8, wherein the amino acid derivative includes at lest one of trimethylglycine, DL-2-aminobutyric acid, and DL-3-amino-n-butanoic acid, and mixtures thereof.

18. The composition of claim 9, wherein the terpene includes at least one of benzyl acetate, sodium salicylate, idebenone, furocoumarine, pinene, 2-carene, phellandrene, coronatine, limonene, and geraniol, and mixtures thereof.

19. A method of making a composition for regulating growth or yield of plants, the method comprising:
selecting a particulate material; and
mixing a plant growth regulating compound with the particulate material, wherein the plant growth regulating compound is selected from the group including non-gaseous plant hormones, amino acids or amino acid derivatives, and terpenes, and mixtures thereof.

20. The method of claim 19, including selecting particulate material having a Block Brightness of about 80 or more.

21. The method of claim 19, wherein the particulate material includes particles, and wherein a substantial portion of the particles has a size less than about 10 microns.

22. The method of claim 19, including mixing an aqueous medium with the particulate material and the plant growth regulating compound.

23. The method of claim 19, including mixing the particulate material with the plant growth regulating compound such that the ratio of the mass of the particulate material to the mass of the plant growth regulating compound in the composition is in the range from about 5:1 to about 1:1×10⁻⁷.

24. The method of claim 19, including selecting particulate material having a Block Brightness of about 80 or more and wherein a substantial portion of the particulate material selected includes particles of a size less than about 10 microns; and wherein the method includes mixing the particulate material with the plant growth regulating compound such that the ratio of the mass of the particulate material to the mass of the plant growth regulating compound in the composition is in the range from about 5:1 to about 1:1×10⁻⁷.

25. The composition of claim 19, wherein the particulate material and the plant growth regulating compound are mixed with an aqueous medium, and wherein the concentration of the plant growth regulating compound in the composition ranges from about 1×10⁻³M to about 1×10⁻⁹M.

26. The method of claim 24, wherein the particulate material is calcined or hydrous kaolin, and wherein the plant growth regulating compound selected is at least one terpene.

27. The composition of claim 24, wherein the plant growth regulating compound comprises at least one cyclic terpenoid.

28. The method of claim 24, wherein the plant growth regulating compound selected is at least one non-gaseous plant hormone.

29. The method of claim 24, wherein the plant growth regulating compound selected is at least one amino acid or amino acid derivative.

30. A method of regulating growth or yield of plants, the method comprising:
applying an aqueous mixture of particulate material and a plant growth regulating compound to the plants, wherein the plant growth regulating compound is at least one of a non-gaseous plant hormone, an amino acid or amino acid derivative, and a terpene, and mixtures thereof; and
utilizing the particulate material in the aqueous mixture on the plants to redirect sunlight and to generally retain portions of the aqueous mixture on the plant for a period of time.

31. The method of claim 30, including applying the aqueous mixture to the plant such that that the ratio of the mass of the particulate material to the mass of the plant growth regulating compound in the composition is in the range from about 5:1 to about 1:1×10⁻⁷.

32. The method of claim 30, wherein the particulate material includes particles, and wherein a substantial portion of the particles has a size less than about 10 microns; and wherein a substantial portion of the particulate material includes a Block Brightness of about 80 or more; and the ratio of the mass of the particulate material to the mass of the plant growth regulating compound in the composition is in the range from about 5:1 to about 1:1×10⁻⁷.

33. The method of claim 30, wherein the plant growth regulating compound is a terpene.

34. The method of claim 30, wherein the plant growth regulating compound is a cyclic terpenoid.

35. The method of claim 30, wherein the plant growth regulating compound is a non-gaseous plant hormone.

36. The method of claim 30, wherein the plant growth regulating compound is an amino acid or amino acid derivative.

37. The method of claim 32, wherein the particulate material is calcined or hydrous kaolin.

38. The composition of claim 30, wherein the particulate material and the plant growth regulating compound are mixed with an aqueous medium, and wherein the concentration of the plant growth regulating compound in the composition ranges from about 1×10⁻³M to about 1×10⁻⁹M.
